(19) United States
(12) Patent Application Publication
(10) Pub. No.: US 2015/0362433 A1
(43) Pub. Date: Dec. 17, 2015

(54) CHEMICAL SENSING DEVICE

(71) Applicant: HEWLETT-PACKARD DEVELOPMENT COMPANY, L.P., Houston, TX (US)

(72) Inventors: Zhang-Lin ZHOU, San Diego, CA (US); Zhiyong LI, Foster City, CA (US); Ansoon KIM, Mountain View, CA (US)

(21) Appl. No.: 14/763,483

(22) PCT Filed: Jan. 25, 2013
(86) PCT No.: PCT/US2013/023218

§ 371 Date: Jul. 24, 2015

(51) Int. Cl. G01N 21/65

(52) U.S. Cl. CPC G01N 21/658; G01N 2201/06113; G01N 2201/068; Y10S 977/954; B82Y 15/00

(57) ABSTRACT

The present disclosure is drawn to chemical sensing devices and associated methods. In an example, a chemical sensing device can include a substrate and an elongated nanostructure having an attachment end and a free end opposite the attachment end, the attachment end affixed to the substrate and the free end comprising a metal having a potential sensing ligand attached thereto via a covalent bond.

### BACKGROUND

Systems for performing molecular analysis can include the use of surface-enhanced Raman spectroscopy (SERS), enhanced fluorescence, enhanced luminescence, and plasmonic sensing, among others. With specific regard to SERS, Raman spectroscopy is a spectroscopic technique used in condensed matter physics and chemistry to study various low-frequency modes in molecular systems. In further detail, in a Raman spectroscopic, an approximately monochromatic beam of light of a particular wavelength range passes through a sample of molecules and a spectrum of scattered light is emitted. The spectrum of wavelengths emitted from the molecule is called a “Raman spectrum” and the emitted light is called “Raman scattered light.” A Raman spectrum can reveal electronic, vibrational, and rotational energies levels of a molecule. Different molecules produce different Ra-man spectrums that can be used like a fingerprint to identify molecules and even determine the structure of molecules. With this and other sensing techniques, enhancing device sensitivity, simplifying sensors, providing additional flexibility, etc., in such devices would be desirable.

### BRIEF DESCRIPTION OF THE DRAWINGS

Additional features and advantages of the invention will be apparent from the detailed description which follows, taken in conjunction with the accompanying drawings, which together illustrate, by way of example, features of the disclosure.

FIG. 1 is a cross-sectional view of a chemical sensing device in accordance with an example of the present disclosure;

FIG. 2 is a cross-sectional view of a chemical sensing device in accordance with an example of the present disclosure;

FIG. 3 is a perspective view of a chemical sensing device in accordance with an example of the present disclosure; and

FIG. 4 is a flow chart of a method in accordance with an example of the present disclosure; and

FIG. 5 is a flow chart of a method in accordance with an example of the present disclosure; and

FIG. 6 is a SERS spectra of a chemical sensing device exposed to Cr(VI) in accordance with an example of the present disclosure.

Reference will now be made to the exemplary embodiments illustrated, and specific language will be used herein to describe the same. It will nevertheless be understood that no limitation of the scope of the disclosure is thereby intended.

### DETAILED DESCRIPTION

Raman spectroscopy can be used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which is ordinarily in the optical frequency domain. The excited molecule then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different molecules or matters has characteristic peaks that can be used to identify the species. As such, Raman spectroscopy is a useful technique for a variety of chemical or bio-logical sensing applications. However, the intrinsic Raman scattering process is very inefficient, and rough metal surfaces, various types of nano-antennas, as well as waveguiding structures have been used to enhance the Raman scattering processes (i.e., the excitation and/or radiation process described above).

The Raman scattered light generated by a compound (or ion) adsorbed on or within a few nanometers of a structured metal surface can be over 100 times greater than the Raman scattered light generated by the same compound in solution or in the gas phase. This process of analyzing a compound is called surface-enhanced Raman spectroscopy (“SERS”). In recent years, SERS has emerged as a routine and powerful tool for investigating molecular structures and characterizing interfacial and thin-film systems, and even enables single-molecule detection. Engineers, physicists, and chemists continue to seek improvements in systems and methods for performing SERS.

Most SERS systems only enhance the electro-magnetic field at certain hot spots. While this can be desirable, in many cases, the analytes are spread evenly on the SERS substrate, such as by simple adsorption. However, only a small fraction of the analytes actually populates the hot spots.

It has been recognized that it would be advantageous to develop a chemical sensing device based on a new class of surface-enhanced Raman spectroscopy (SERS) structures. Specifically, the present devices can contain a plurality of elongated nanostructures affixed to a substrate with a free end having a metallic coating or cap. The present nanostructures can flex and trap molecules which can then be sensed using SERS techniques. Further, the present nanostructures generally include ligands attached to the metallic coating or cap that can provide selectivity and sensitivity previously unachieved.

It is noted that when discussing a chemical sensing device, a method detecting a target molecule, or a method of making a chemical sensing device, each of these discussions can be considered applicable to the other embodiment, whether or not they are explicitly discussed in the context of that embodiment. Thus, for example, in discussing a ligand for a chemical sensing device, such a ligand can also be used in a method of detecting a target molecule, and vice versa.

Thus, a chemical sensing device can include a substrate and an elongated nanostructure having an attachment end and a free end opposite the attachment end, the attachment end affixed to the substrate and the free end including a metal having a potential sensing ligand attached thereto via a covalent bond.

As used herein, the term “nanostructure” refers to any structure having dimensions of width or diameter less than 1 micron. As such, an elongated nanostructure can include structures that have an aspect ratio with a length at least two times longer than the shortest width. Examples can include nanocones, nanopyramids, nanorods, nanobars, nanofingers, nanopoles and nanograss, without limitation thereto. As used herein, the terms “nanocones,” “nanopyramids,” “nanorods,” “nanobars,” “nanopoles” and “nanograss,” refer to structures that are substantially: conical, pyramidal, rod-like, bar-like, pole-like and grass-like, respectively, which have nano-dimensions as small as a few tens of nanometers (nm) in height and a few nanometers in diameter, or width. For example, flexible columns may include nano-columns having the following dimensions: a diameter of 10 nm to 500 nm, a height of 20 nm to 2 micrometers (μm), and a gap between flexible columns of 20 nm to 500 nm. The terms of art, “substantially conical,” “substantially pyramidal,” “substantially rod-like,” “substantially bar-like,” “substantially pole-like” and “substantially grass-like,” refers to structures that have nearly the respective shapes of cones, pyramids, rods, bars, poles and grass-like asperities within the limits of fabrication with nanotechnology.

As used herein, the term “metallic cap” refers to nanostructures, including nanospheres, prolate nanoellipsoids, oblate nanoellipsoids, nanodisks, and nanoplates, having a width or diameter of 500 nm or less. In one example, the metallic cap may possess shape-induced magnetic anisotropy. As used herein, the terms “nanospheres,” “prolate nanoellipsoids,” “oblate nanoellipsoids,” “nanodisks,” and “nanoplates,” refer to structures that are substantially: spherical, prolate ellipsoidal, oblate ellipsoidal, disk-like, and plate-like, respectively, which have nano-dimensions as small as a few nanometers in size: height, diameter, or width. In addition, the terms “substantially spherical,” “substantially prolate ellipsoidal,” “substantially oblate ellipsoidal,” “substantially disk-like,” and “substantially and plate-like,” refers to structures that have nearly the respective shapes of spheres, prolate ellipsoids, oblate ellipsoids, disks, and plates within the limits of fabrication with nanotechnology.

Generally, the elongated nanostructure can include a non-metallic column with a metallic coating or metallic cap. In one example, the nanostructure can include a polymer, such as a resist, coated with a SERS-active metal, such as gold, silver, copper, platinum, aluminum, etc. or the combination of those metals in the form of alloys. Generally, the SERS active metal can be selectively coated on the tips of the non-metallic column or deposited thereon. In addition, the SERS active metal can be a multilayer structure, for example, 10 to 100 nm silver layer with 1 to 50 nm gold over-coating, or vice versa. Additionally, the SERS active metal can be further coated with a thin dielectric layer.

Generally, the use of a polymer can render the nanostructures sufficiently flexible to permit the bending so that the tips meet at the top of the structure. Examples of suitable polymers include, but are not limited to, polymethyl methacrylate (PMMA), polycarbonate, siloxane, polydimethylsiloxane (PDMS), photoresist, nanoimprint resist, and other thermoplastic polymers and UV curable materials including one or more monomers/oligomers/polymers. In another example, the nanostructures can include an inorganic material having sufficient flexibility to bend. Examples of such inorganic materials include silicon oxide, silicon, silicon nitride, alumina, diamond, diamond-like carbon, aluminum, copper, and the like.

The chemical sensing device generally includes potential sensing ligands attached to the metallic coating or cap. In one example, the potential sensing ligand can include an attachment functional group(A), a spacer group (B), and a potential sensing moiety (PS) according to Formula I:

A—B—PS (I) Formula I

where A is an organic functional group attached to the nanostructure, B is substituted or unsubstituted, linear or branched alkyl or aryl, and PS is an organic functional group capable of binding to a target molecule. The functional group can include any group that is capable of covalent bonding to the metal coating or cap. The potential sensing moiety can include any moiety that is capable of interacting (including ionic, coordinate, covalent bonding) with a target molecule. The spacer group generally includes any group of atoms that covalently bond the functional group to the potential sensing moiety. For example, in one aspect, the metal can include gold and the functional group can include a thiol that covalently bonds to the gold. The ligand can further include an alkyl spacer group with an amine potential sensing moiety. For example, without be limiting, 3-aminopropylthiol would qualify as such a ligand, although other aminoalkylthiols would also qualify. Various functional groups can include primary amines, secondary amines, tertiary amines, amides, nitriles, isonitriles, cyanates, isocyanates, thiocyanates, isothiocyanates, azides, thiols, thiolates, sulfides, sulfinates, sulfonates, phosphates, hydroxyls, alcoholates, phenolates, carbonyls, carboxylates, phosphines, phosphine oxides, phosphonic acids, phosphoramides and phosphates. Additionally, various potential sensing groups can include functional groups as discussed herein, alone, or in combination with more complex structures, e.g., methyl red dyes, carboxyfluorescein dyes, carboxyrhodamine dyes, cyanine dyes, crown-ethers, polyamines etc. Particularly, a list of examples of potential sensing groups includes 4-pyridinethiol, 3-pyridinethiol, 2-pyridinethiol, 4-pyridinemethanethiol, 3-pyridinemethanethiol, 2-pyridinemethanethiol, 4-pyridineethanethiol, 3-pyridineethanethiol, 2-pyridineethanethiol, 4-pyridinepropanethiol, 3-pyridinepropanethiol, 2-pyridinepropanethiol, 4-pyridinebutanethiol, 3-pyridinebutanethiol, 2-pyridinebutanethiol, 4-pyridinepentanethiol, 3-pyridinepentanethiol, 2-pyridinepentanethiol, etc.

The chemical sensing device generally includes a potential sensing ligand formulated to selectively bind a target molecule. The target molecule can be a metal ion, an organic compound, or a hydrogen ion. In one example, the target molecule is a metal ion and the potential sensing ligand is formulated to selectively bind the metal ion. In one example, the metal ions can include chromium, lead, mercury, zinc, calcium, sodium, hydrogen, potassium, arsonium, and mixtures thereof.

By using the present potential sensing ligands, the chemical sensing device can be sensitive enough to detect a target molecule; including a metal ion, an organic compound, or a hydrogen ion, at a concentration as low as 1 part-per-million (ppm). In one aspect, the sensitivity can be as low as 1 part-per-billion (ppb), and in one specific aspect, as low as 1 part-per-trillion (ppt).

Regarding sensitivity, the present chemical device can include a plurality of elongated nanostructures attached to a substrate forming an array. In one example, the array can include sub-arrays. In one aspect, the sub-arrays can each have individual selectivity for a target molecule. As such, one array can have selectivity for a plurality of target molecules. The chemical sensing device can be further configured to detect the target molecule from a liquid or gas.

Additionally, the chemical sensing device can further include a detector operatively coupled to the nanostructure. In one example, the detector can be a colorimeter, a reflectometer, a spectrometer, a spectrophotometer, a Raman spectrometer, an optical microscope, and/or an instrument for measuring luminescence.

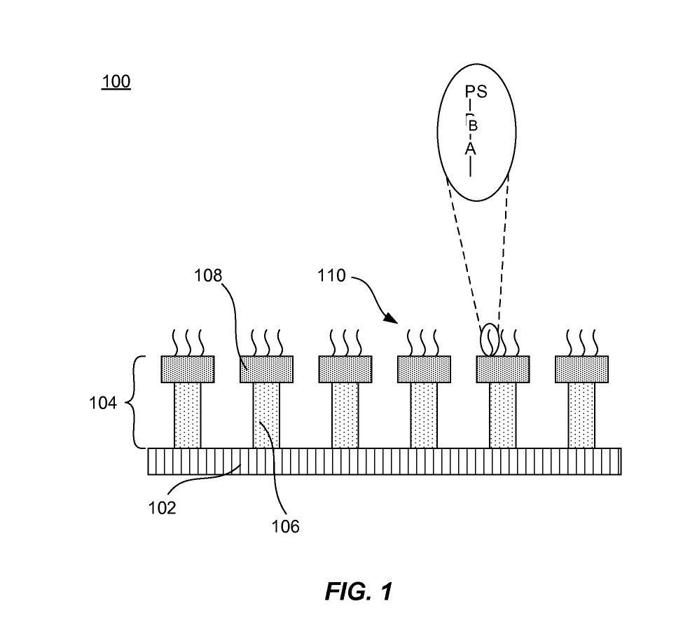

Referring to FIG. 1, a chemical sensing device 100 can include a substrate 102 having an elongated nanostructure 104 attached thereto. The elongated nanostructure has a columnar structure 106 with a metallic cap 108 deposited thereon. Further, potential sensing ligands 110 can be covalently bonded to the metallic cap. As shown in the insert, the potential sensing ligands can generally includes the structure A—B—PS, where A is a functional group that binds the ligand to the metallic cap, B is a spacer group, and PS is a potential sensing moiety coupled to the functional group through the spacer group. While the present figure provides a specific structure of the chemical sensing device, it is understood that the illustrated structure is not intended to be limiting and that the present disclosure contemplates the use of various elements as discussed herein. For example, the present metallic cap could also be a metallic coating.

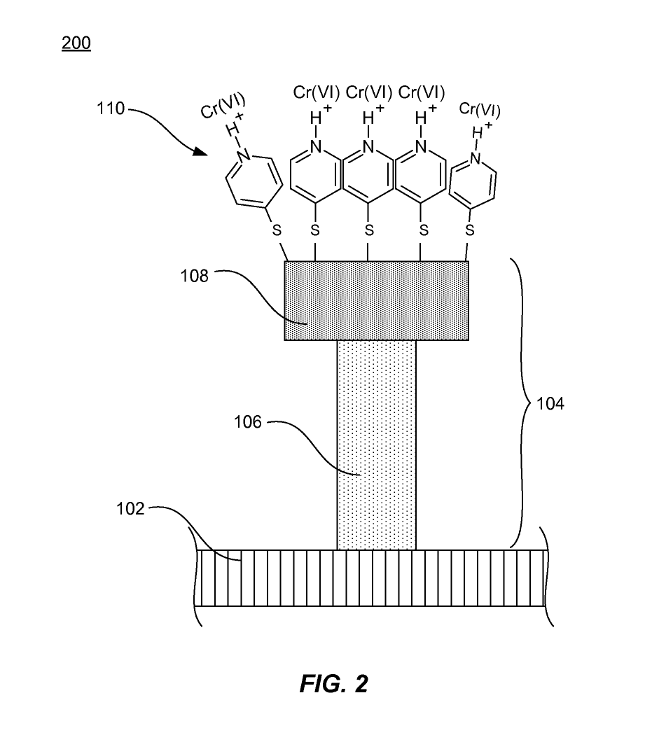

Referring to FIG. 2, an expanded view of a single elongated nanostructure having ligands bonded thereto is illustrated. It is noted that the elements of FIG. 2 are not necessarily drawn to scale, nor does it represent every chemical sensing device available for use herein, i.e. it provides merely an exemplary embodiment of one chemical sensing device having one specific set of ligands. In this example, the chemical sensing device 200 can include a substrate 102 having an elongated nanostructure 104 attached thereto. The elongated nanostructure can include a columnar structure 106 with a metallic cap 108 deposited thereon. A plurality of pyridinium potential sensing moieties 110 are attached to the metallic cap via a thiol linkage. The pyridinium potential sensing moieties are shown as binding to chromium (VI) in this specific example.

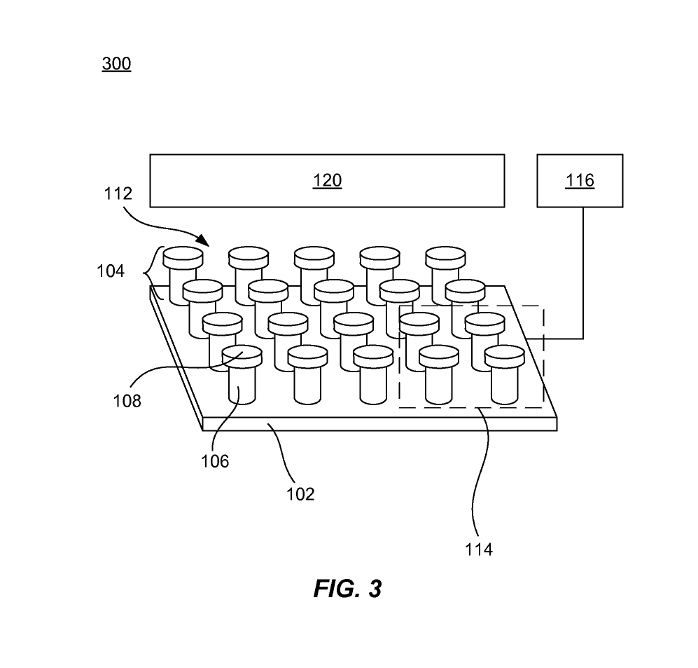

Referring to FIG. 3, a chemical sensing device 300 can include a substrate 102 having an elongated nanostructures 104 attached thereto. The elongated nanostructures can include columnar structures 106 with a metallic caps 108 deposited thereon. The metallic caps can have ligands (not shown) attached thereto as well. The plurality of nanostructures can form an array 112 with a sub-array 114. The chemical sensing device can further include a detector 116 operatively coupled to the nanostructures. Additionally, a source of excitation energy 120, such as a light source or a laser source, is also shown.

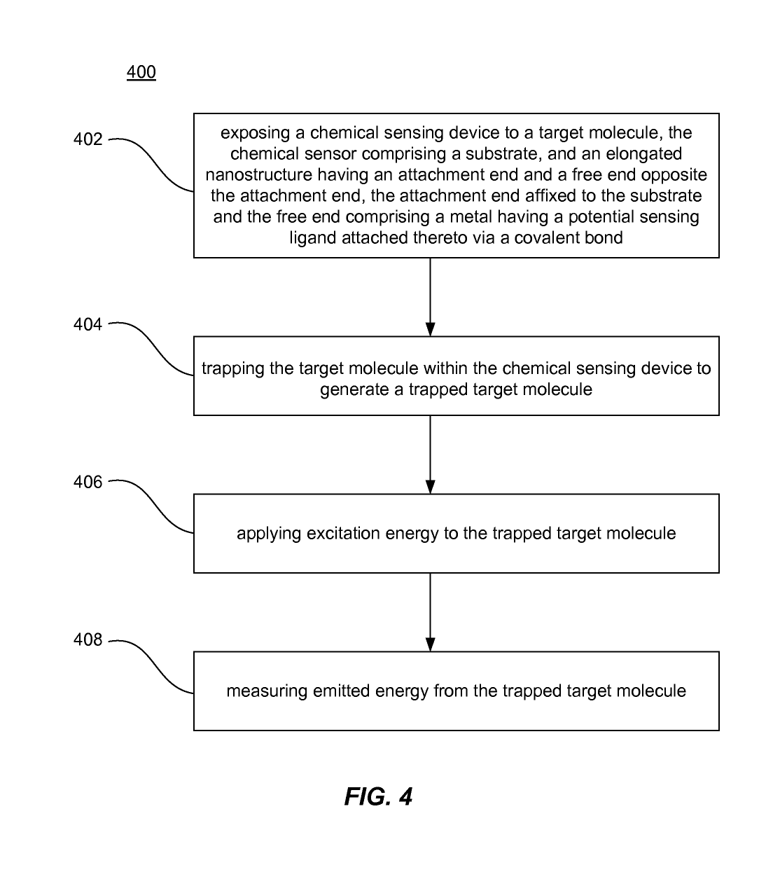

Referring to FIG. 4, a method for detecting a target molecule 400 can include exposing 402 a chemical sensing device to a target molecule, the chemical sensing device including any of those described herein, trapping 404 the target molecule within the chemical sensing device to generate a trapped target molecule; applying 406 excitation energy to the trapped target molecule; and measuring 408 emitted energy from the trapped target molecule. In one example, the excitation energy and the emitted energy can be electromagnetic energy. Additionally, the method can further include flushing the trapped metal target molecule from the chemical sensing device. As such, the present devices can be reusable and/or can be recyclable.

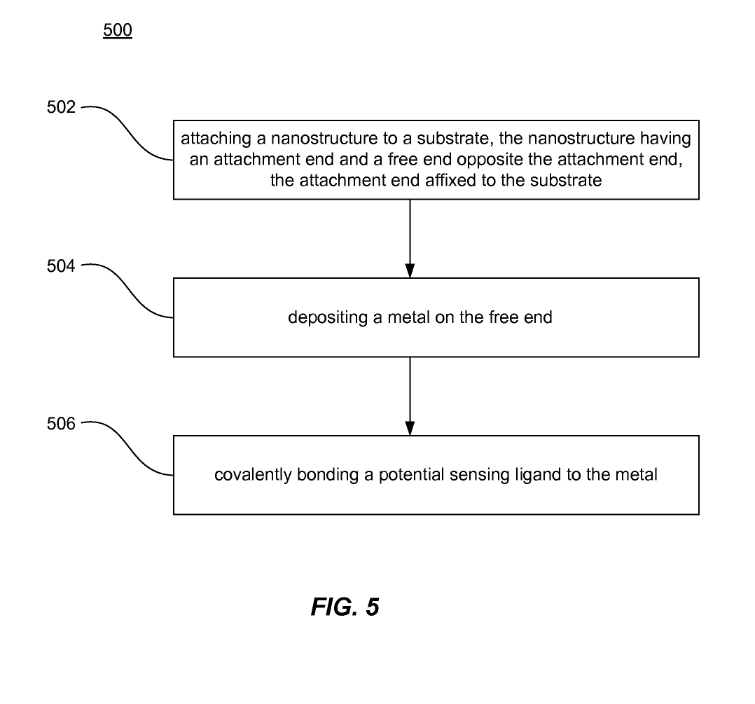

Referring to FIG. 5, a method of making a chemical sensing device 500 can include disposing 502 a nanostructure to a substrate, the nanostructure having an attachment end attached to the substrate and a free end opposite the attachment end, the attachment end affixed to the substrate; depositing 504 a metal on the free end; and covalently bonding 506 a potential sensing ligand to the metal.

It is noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

### EXAMPLES

The following examples illustrate embodiments of the disclosure that are presently known. Thus, these examples should not be considered as limitations of the invention, but are merely in place to teach how to make devices of the present disclosure. As such, a representative number of devices and their method of manufacture are disclosed herein.

### Example 1

### General Preparation Method for Modifying Gold Elongated Nanostructure with Potential Sensing Ligand

Immobilizing a potential sensing moiety to a gold surface on a nanostructure can be carried out with surface modification by treating the gold nanostructure with chemical reagents. A reactant moiety A is introduced on the surface. Additionally, a reactant moiety B having a potential sensing (PS) moiety bound thereto is reacted with the reactant moiety A. For example, the modified substrate can be dipped into the solutions of potential sensing moieties bound to the reactant moiety B. The reactant moieties A and B react heterogeneously but neither react homogeneously to form a covalent bond between the substrate and the potential sensor moiety, thus immobilizing the potential chemical sensing moiety onto the gold coated nanostructure surface.

### Example 2

### Preparation of Gold Elongated Nanostructure with Potential Sensing Ligand

Surface modification of a gold nanostructure is performed with 3-aminopropylthiol providing a modified surface with a reactive amino group, which is reactive towards an activated ester. The modified gold nanostructure is then treated with a solution of the activated ester, where the activated ester includes a potential sensing moiety. The reaction between the activated ester and the amino group takes place, forming a covalent bond between the potential sensing molecular moiety and the gold nanostructure surface via the propylthiol linkage.

### Example 3

### Preparation of Gold Elongated Nanostructure with Potential Sensing Ligand

The present example sets for the preparation of a nanostructure modified with a pH indicator to sense acidity. First, commercially available methyl red is modified with DSC (N,N′-disuccinimidyl carbonate) in the presence of catalytic amount of 3-dimethylaminopyridine to give modified methyl red with reactive succinimidyl group. Second, a gold nanostructure is modified with the solution of 3-aminopropylthiol, generating a modified gold nanostructure with a reactive amino group on the surface. When the modified nanofinger is treated with the modified methyl red, a reaction between the surface and the dye takes place, forming a gold nanofinger attached with methyl red dye, which can be used for detecting proton ion H⁺.

### Example 4

### Alternative General Preparation Method for Modifying Gold Elongated Nanostructure with Potential Sensing Ligand

Another approach is to first modify the potential sensing moiety with certain chemical reagents to form a modified potential sensing moiety with reactive groups, which are reactive towards gold nanostructure surfaces. For example, an activated ester having a potential sensing moiety can be treated with commercially available 3-aminopropylthiol, and the reaction between the amino group with the activated ester takes place, generating a modified potential sensing moiety coupled to a reactive thiol group, which is reactive towards gold nanostructure surface. When the untreated gold nanostructure is treated with the modified potential sensing moiety coupled to a reactive thiol group, a chemical reaction between the thiol group and gold surface takes place to form a chemical bond, thus immobilizing the potential sensing moiety on the gold nanostructure surface.

### Example 5

### Preparation of Gold Elongated Nanostructure with Potential Sensing Ligand

Reaction of methyl red dye with 3-aminopropylthiol in the presence of coupling reagent such as N,N′-dicyclohexylcarbodiimide (DCC) forms a modified methyl red with thiol group on the end, which is reactive towards a gold surface. When a gold nanostructure is treated with the modified methyl red, a covalent bond forms between the gold nanostructure and methyl red. Thus, the methyl dye is immobilized on the gold nanostructure surface, which can be used for detection of proton ions H⁺.

### Example 6

### Preparation of Gold Elongated Nanostructure with Potential Sensing Ligand

Nanostructures (referred to as “NS” in Scheme 1 below) can be used to detect metal ions, such as chromium (VI). As shown in Scheme 1: Reaction of 4-vinylpyridine with thiourea in the presence of p-toluenesulfonic acid gave intermediate 2. Treatment of intermediate 2 with ammonium hydroxide formed 4-pyridineethantiol 3, which can be converted into HCl salt 4. Upon careful neutralization of HCl salt 4 with a base, it can be self-assembled into a gold nanostructure (NS) surface. Since the pyridine can form a coordination bond with Cr (VI), it can be used for highly sensitive and selective detection of chromium (VI).

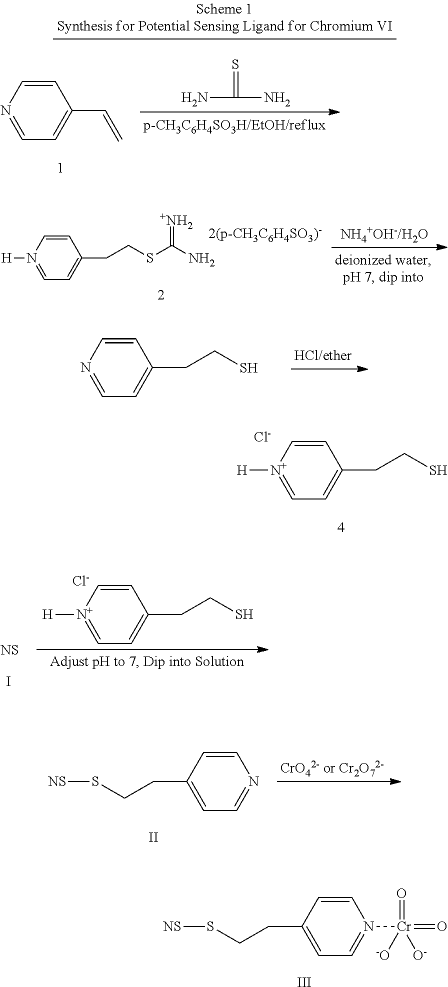

### Example 7

### Preparation of Gold Elongated Nanostructure with Potential Sensing Ligand

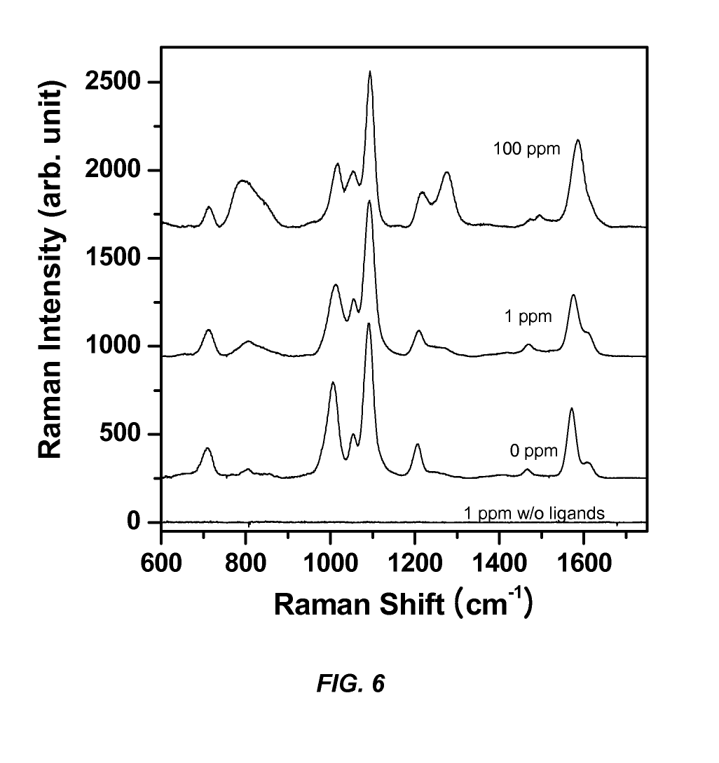

A gold nanostructure was prepared by treatment of the surface of the gold with 4-mercaptopyridine. A gold nanostructure was dipped without stirring into a solution of ethanol containing 4-mercaptopyridine for 24 hrs at room temperature, followed by being rinsed with pure ethanol solvent. In order to prepare a cationic pyridinium form of the functionalized 4-mercaptopyridine, the gold nanostructure was re-dipped in 0.1 M sulfuric acid for 30 min. The pyridinium-functionalized nanostructure was then exposed to varying amount of Cr(VI) as shown in FIG. 6. Notably, the SERS detected the presence of Cr(VI) at concentrations as low as 1 ppm. Further, based on the data obtained, lower thresholds appear possible as the spectra is clearly resolvable between 0 ppm and 1 ppm. As a comparison, the bottom flat line represents the same nanostructure exposed to Cr(VI), except no ligands were attached thereto. Notably, the spectra show no activity. The evidence provided in FIG. 6 shows that the present ligands provide detectability of a metal ion otherwise unachieved, with a sensitivity down to 1 ppm.

While the invention has been described with reference to certain examples, those skilled in the art will appreciate that various modifications, changes, omissions, and substitutions can be made without departing from the spirit of the invention. It is intended, therefore, that the invention be limited only by the scope of the following claims.

What is claimed is:

1. A chemical sensing device, comprising:
a substrate; and
an elongated nanostructure having an attachment end and a free end opposite the attachment end, the attachment end affixed to the substrate and the free end comprising a metal having a potential sensing ligand attached thereto via a covalent bond.

2. The chemical sensing device of claim 1, wherein the nanostructure comprises a non-metallic column with a metallic coating or metallic cap.

3. The chemical sensing device of claim 1, wherein the potential sensing ligand comprises an attachment functional group(A), a spacer group (B), and a potential sensing moiety (PS) according to formula I:
A—B—PS (I)
wherein A is an organic functional group attached to the nanostructure, B is substituted or unsubstituted, linear or branched, alkyl or aryl, and PS is an organic functional group capable of binding to a target molecule.

4. The chemical sensing device of claim 1, wherein the metal is selected from the group of: gold, silver, copper, aluminum, platinum, and mixtures thereof.

5. The chemical sensing device of claim 1, wherein the potential sensing ligand is formulated to selectively bind a metal ion, an organic compound, or a hydrogen ion.

6. The chemical sensing device of claim 5, wherein the potential sensing ligand is formulated to selectively bind the metal ion, and wherein the metal ion is selected from the group of: chromium, lead, mercury, zinc, calcium, sodium, hydrogen, potassium, arsonium, and mixtures thereof.

7. The chemical sensing device of claim 5, wherein the chemical sensing device is sensitive enough to detect the metal ion, the organic compound, or the hydrogen ion at a concentration as low as 1 ppt.

8. The chemical sensing device of claim 1, further comprising a detector operatively coupled to the nanostructure, the detector selected from the group of a colorimeter, a reflectometer, a spectrometer, a spectrophotometer, a Raman spectrometer, an optical microscope, and an instrument for measuring luminescence.

9. The chemical sensing device of claim 1, further comprising a plurality of the elongated nanostructures attached to the substrate forming an array.

10. The chemical sensing device of claim 9, wherein the array includes sub-arrays, the sub-arrays having individual selectivity for a target molecule, the target molecule selected from the group of a metal ion, an organic compound, and a hydrogen ion.

11. The chemical sensing device of claim 9, wherein the chemical sensor can detect the target molecule from a liquid or gas.

12. A method for detecting a target molecule, comprising
exposing a chemical sensing device to a target molecule, the chemical sensor comprising:
a substrate, and
an elongated nanostructure having an attachment end and a free end opposite the attachment end, the attachment end affixed to the substrate and the free end comprising a metal having a potential sensing ligand attached thereto via a covalent bond;
trapping the target molecule within the chemical sensing device to generate a trapped target molecule;
applying excitation energy to the trapped target molecule; and
measuring emitted energy from the trapped target molecule.

13. The method of claim 12, wherein the excitation energy and the emitted energy is electromagnetic energy and the target molecule is selected from the group of a metal ion, an organic compound, and a hydrogen ion.

14. The method of claim 12, further comprising flushing the trapped metal target molecule from the chemical sensing device.

15. A method of making a chemical sensing device, comprising:
disposing a nanostructure on a substrate, the nanostructure having an attachment end attached to the substrate and a free end opposite the attachment end, the attachment end affixed to the substrate;
depositing a metal on the free end; and
covalently bonding a potential sensing ligand to the metal.
